(19) United States
(12) Patent Application Publication
(10) Pub. No.: US 2023/0077852 A1
(43) Pub. Date: Mar. 16, 2023

(54) ROUTING APPARATUS, ROUTING METHOD, AND NON-TRANSITORY COMPUTER-READABLE STORAGE MEDIUM STORING ROUTING PROGRAM

(71) Applicant: Woven Planet Holdings, Inc., Tokyo (JP)

(72) Inventor: Toshinobu WATANABE, Tokyo-to (JP)

(21) Appl. No.: 17/812,269

(22) Filed: Jul. 13, 2022

(30) Foreign Application Priority Data
Sep. 13, 2021 (JP) 2021-148875

(51) Int. Cl. G01C 21/34; G05D 1/00

(52) U.S. Cl. CPC G01C 21/3461; G05D 1/0027; G05D 2201/0213

(57) ABSTRACT

The routing apparatus executes the following first to fourth processes. The first process is to predict occurrence of remote assistance for each of a plurality of route candidates for each of a plurality of vehicles. The second process is to calculate a remote assistance period for each remote assistance of which the occurrence is predicted. The third process is to calculate a time-based required number of operators based on an overlap of remote assistance periods for all combinations of the plurality of route candidates between the plurality of vehicles. The fourth process is to select a combination of route candidates that minimizes a maximum value of the time-based required number of operators among all the combinations of the plurality of route candidates for the plurality of vehicles.

### CROSS-REFERENCE TO RELATED APPLICATION

The present application claims priority under 35 U.S.C. § 119 to Japanese Patent Application No. 2021-148875, filed Sep. 13, 2021, the contents of which application are incorporated herein by reference in their entirety.

### BACKGROUND

### Field

The present disclosure relates to a routing apparatus, a routing method, and a routing program for selecting a route on which a vehicle capable of autonomous traveling and subject to remote assistance by an operator travels from among a plurality of route candidates for each vehicle.

### Background Art

An autonomous vehicle basically travels autonomously. However, there are cases where autonomous judgement by the autonomous vehicle is uncertain or more sure safety judgement is required. Therefore, it has been considered not to leave everything to the autonomous judgement by the autonomous vehicle but to assist the autonomous traveling of the autonomous vehicle by monitoring the autonomous vehicle remotely and, if necessary, transmitting determination and remote traveling instruction to the vehicle from an operator. One of the prior art related to remote monitoring of the autonomous vehicle is disclosed in JP2019-160146A.

According to the prior art disclosed in JP2019-160146A, a route along which a vehicle reaches a destination is specified, and a start timing of remote assistance of the vehicle by an operator is predicted based on a scheduled time at which the vehicle arrives at an assistance point included in the specified route. Then, the required number of operators for each time zone is calculated based on the arrival timing at the assistance point in each route and the required time for each assistance point.

In the above-described prior art, a route for each vehicle to travel is selected from a plurality of route candidates for each vehicle. However, when each vehicle independently selects the optimal route, the vehicles concentrate on one route, and there is a possibility that a time zone in which the required number of operators increases occurs.

As prior art documents representing the technical level of the technical field to which the present disclosure belongs, in addition to JP2019-160146A, JP2019-190835A and JP2019-185279A can be exemplified.

### SUMMARY

The present disclosure has been made in view of the above-described problem. An object of the present disclosure is to provide a technique capable of reducing the required number of operators who perform remote assistance on a vehicle capable of autonomous traveling.

The present disclosure provides a routing apparatus for achieving the above object. The routing apparatus of the present disclosure is an apparatus for selecting a route of a vehicle from a plurality of route candidates for each vehicle, being applied to a remote monitoring system configured to cause a plurality of operators to remotely monitor a plurality of vehicles capable of autonomous traveling. The remote monitoring system is a system to cause any one of the plurality of operators to perform remote assistance in response to an assistance request from any one of the plurality of vehicles.

The routing apparatus of the present disclosure comprises at least one memory storing at least one program and at least one processor coupled to the at least one memory. The at least one program is configured to cause the at least one processor to execute processing comprising the following processes.

A first process is to predict occurrence of remote assistance for each of a plurality of route candidates for each of the plurality of vehicles.

A second process is to calculate a remote assistance period for each remote assistance of which the occurrence is predicted.

A third process is to calculate a time-based required number of operators based on an overlap of remote assistance periods for all combinations of the plurality of route candidates between the plurality of vehicles.

A fourth process is to select a combination of route candidates that minimizes a maximum value of the time-based required number of operators among all the combinations of the plurality of route candidates for the plurality of vehicles. By executing the first to fourth processes, the number of operators who perform remote assistance can be minimized.

The fourth process may include, when there are a plurality of combinations of route candidates that minimize a maximum value of the time-based required number of operators, selecting a combination of route candidates that minimizes total remote assistance period. By performing such selection, it is possible to minimize the load on the operators as a whole who perform remote assistance.

Also, the present disclosure provides a routing method for achieving the above object. The routing method of the present disclosure is a method applied to a remote monitoring system configured to cause a plurality of operators to remotely monitor a plurality of vehicles capable of autonomous traveling and cause any one of the plurality of operators to perform remote assistance in response to an assistance request from any one of the plurality of vehicles. This routing method is a method of selecting a route of a vehicle from a plurality of route candidates for each vehicle. The routing method includes the following steps.

A first step is to predict occurrence of remote assistance for each of the plurality of route candidates for each of the plurality of vehicles.

A second step is to calculate a remote assistance period for each remote assistance of which the occurrence is predicted.

A third step is to calculate a time-based required number of operators based on an overlap of remote assistance periods for all combinations of the plurality of route candidates between the plurality of vehicles.

A fourth process is to select a combination of route candidates that minimizes a maximum value of the time-based required number of operators among all the combinations of the plurality of route candidates for the plurality of vehicles. By executing the first to fourth steps, the number of operators who perform remote assistance can be minimized.

The fourth process may include, when there are a plurality of combinations of route candidates that minimize a maximum value of the time-based required number of operators, selecting a combination of route candidates that minimizes total remote assistance period. By performing such selection, it is possible to minimize the load on the operators as a whole who perform remote assistance.

Further, the present disclosure provides a routing program for achieving the above object. The routing program of the present disclosure may be stored on a non-transitory computer-readable storage medium. The routing program of the present disclosure is a program for selecting a route of a vehicle from a plurality of route candidates for each vehicle, being applied to a remote monitoring system configured to cause a plurality of operators to remotely monitor a plurality of vehicles capable of autonomous traveling. The remote monitoring system is a system to cause any one of the plurality of operators to perform remote assistance in response to an assistance request from any one of the plurality of vehicles. The routing program of the present disclosure is configured to cause the computer to execute processing comprising the following processes.

A first process is to predict occurrence of remote assistance for each of a plurality of route candidates for each of the plurality of vehicles.

A second process is to calculate a remote assistance period for each remote assistance of which the occurrence is predicted.

A third process is to calculate a time-based required number of operators based on an overlap of remote assistance periods for all combinations of the plurality of route candidates between the plurality of vehicles.

A fourth process is to select a combination of route candidates that minimizes a maximum value of the time-based required number of operators among all the combinations of the plurality of route candidates for the plurality of vehicles. By executing the first to fourth processes, the number of operators who perform remote assistance can be minimized.

As described above, according to the routing apparatus, the routing method, and the routing program of the present disclosure, it is possible to reduce the required number of operators who perform remote assistance on a vehicle capable of autonomous traveling.

### BRIEF DESCRIPTION OF THE DRAWINGS

FIG. 1 is an overall view of a remote monitoring system to which a routing apparatus according to an embodiment of the present disclosure is applied.

FIG. 2 is a diagram for explaining routes of autonomous vehicles.

FIG. 3 is a block diagram showing an example of a configuration of the routing apparatus according to the embodiment of the present disclosure.

FIG. 4 is a diagram illustrating extraction of route candidates by the routing apparatus according to the embodiment of the present disclosure.

FIG. 5 is a diagram illustrating selection of a combination of route candidates by the routing apparatus according to the embodiment of the present disclosure.

FIG. 6 is a diagram illustrating selection of an optimal route by the routing apparatus according to the embodiment of the present disclosure.

FIG. 7 is a flowchart illustrating a procedure for selecting an optimal route by the routing apparatus according to the embodiment of the present disclosure.

### DETAILED DESCRIPTION

Hereunder, an embodiment of the present disclosure will be described with reference to the drawings. However, in the embodiment described below, when a numerical value such as the number, quantity, amount, or range of each element is mentioned, the technical idea according to the present disclosure is not limited to the mentioned numerical value except for a case where it is clearly specified in particular or a case where it is clearly specified to the numerical value in principle. In addition, a structure or the like described in the embodiment described below is not necessarily essential to the technical idea according to the present disclosure except for a case where it is clearly specified in particular or a case where it is clearly specified in principle.

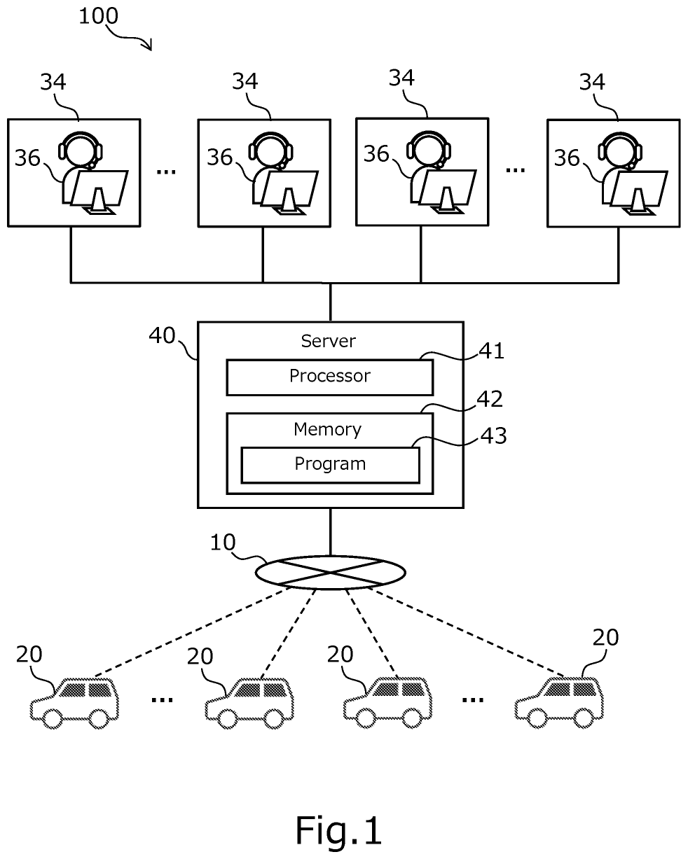

FIG. 1 is a configuration diagram of a remote monitoring system 100 for remotely monitoring autonomous vehicles 20. The remote monitoring system 100 is a system for remotely monitoring a plurality of autonomous vehicles 20 by a plurality of operators 36. However, not all of the autonomous vehicles 20 are constantly monitored by the operators 36. In the remote monitoring system 100, if there is a request for remote assistance from the autonomous vehicle 20 to be monitored, any one of the available operators 36 is assigned and the assigned operator 36 is caused to perform remote assistance. As the driving automation level of the autonomous vehicle 20 to be subject to remote monitoring in the remote monitoring system, for example, level 3 or more is assumed according to the definition of SAE (Society of Automotive Engineers). Hereinafter, the autonomous vehicle 20 is simply referred to as a vehicle 20.

In remote assistance by the remote monitoring system 100, at least a part of the determination for automatic driving by the vehicle 20 is performed by the operator 36. If there is no remote assistance by the operator 36, the determination of the autonomous traveling of the vehicle 20 must be conservative. Therefore, there is a concern that the traffic flow around the vehicle 20 may be affected by the vehicle 20 stopping or slowing down while traveling. However, in the remote monitoring system 100, remote assistance by the operator 36 can be obtained in case of the emergency, the vehicle 20 can perform an aggressive autonomous traveling such as traveling the shortest route to the destination.

When the vehicle 20 performs aggressive autonomous traveling, remote assistance by the operator 36 is predicted to be required by the following factors, for example.

a. Misrecognition of traffic signal and non-detection of traffic signal (backlit, hidden by tracks, etc., signal without V2X)
b. Unstable recognition of preceding vehicle (the preceding vehicle is black or motorcycle with long distance form ego-vehicle, which is difficult to detect by LiDAR)
c. Crossing sidewalks with pedestrians and bicycles
d. Lane change on road with heavy on-road parking
e. Correction of stopping position (for responding to on-road parking, traffic jams, or obstacles)
f Confirmation of surroundings when departing
g. Lane change for road construction and traffic control

In remote assistance, basic calculations regarding recognition, judgment, and operation required for driving are executed by the vehicle 20. The operator 36 determines what action the vehicle 20 should take based on the information transmitted from the vehicle 20 and gives instructions to the vehicle 20. The information transmitted from the vehicle 20 includes, for example, the image information of the periphery of the vehicle 20 captured by the vehicle-mounted camera, the voice information of the periphery of the vehicle 20 collected by the vehicle-mounted microphone, the target trajectory calculated by the vehicle 20 and the like. The instructions for remote assistance sent from the operator 36 to the vehicle 20 include an instruction to advance the vehicle 20 and an instruction to stop the vehicle 20. In addition, the instructions for remote assistance include an instruction to avoid an obstacle ahead, an instruction to overtake a preceding vehicle, and an instruction to evacuate emergently.

The remote monitoring system 100 includes a server 40. An operation terminal 34 operated by the operator 36 is connected to the server 40. Further, the vehicle 20 to be monitored by the remote monitoring system 100 is connected to the server 40 via a communication network 10 including a 4G or 5G. The server 40 may be located, for example, on a monitoring center or cloud.

The server 40 may be a computer or a collection of computers connected in a communication network. The server 40 includes at least one processor 41 (hereinafter, refer to as a processor 41) and at least one memory 42 (hereinafter, refer to as a memory 42) coupled to the processor 41. The memory 42 stores at least one program 43 (hereinafter, refer to as a program 43) execute by the processor 41 and various related information. The memory 42 includes a main storage device and an auxiliary storage device. The program 43 can be stored in the main storage device or in the auxiliary storage device. The auxiliary storage device stores a map database for managing map information for automatic driving.

When the processor 41 executes the program 43, various kinds of processing are executed by the processor 41. The program 43 includes a program to determine which operator 36 is assigned to the vehicle 20 requesting remote assistance upon request of remote assistance from the vehicle 20. After the operator 36 to be assigned is determined, the operation terminal 34 of the operator 36 and the vehicle 20 are connected to initiate communication for remote assistance.

Further, the program 43 includes a program (routing program) for causing the server 40 to function as a routing apparatus. The route to the destination of the vehicle 20 is provided from the server 40. The route to the destination is created based on the map information managed by the map database. There are multiple routes to destinations that the vehicle 20 may take. The function of the server 40 as a routing apparatus is a function of selecting a route from among a plurality of route candidates for each vehicle 20.

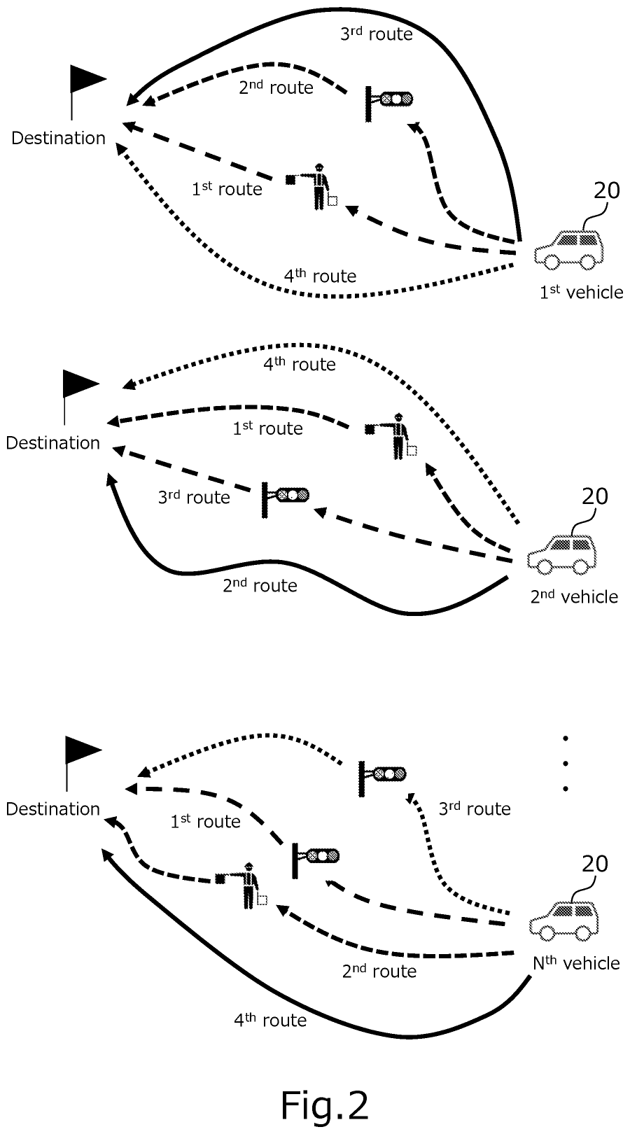

Here, an outline of the route selection by the server 40 as a routing apparatus will be described with reference to FIG. 2. Here, it is assumed that the N vehicles from the first vehicle to the Nth vehicle is monitored by the remote monitoring system 100. The server 40 generates a plurality of route candidates for each vehicle 20 and updates the route candidates according to the progress of the vehicle 20. That is, the server 40 generates a plurality of route candidates from the current location of the vehicle 20 to the destination at predetermined time intervals or at predetermined traveling distances. For example, the current route candidates for the first vehicle are four routes from the first route to the fourth route. However, one of them is the current route. Here, if the fourth route is selected, the first to third routes are erased, new route candidates are generated according to the position of the first vehicle after a predetermined time or after traveling a predetermined distance.

For each of the generated route candidates, the server 40 determines whether or not there are any of the factors listed above that are predicted to require remote assistance. In the example shown in FIG. 2, among the route candidates of the first vehicle, the first route includes a road construction section, and the second route includes a signal without V2X. In the road construction section, it is predicted that an assistance request will be generated for determination of the guidance of the guiding person and the surrounding situation. At the installation position of the traffic signal without V2X, it is predicted that an assistance request will be generated for determination of the lighting color of the signal and the surrounding situation. An assistance request predicted to occur in the future as in these examples may be referred to as a potential assistance request.

In the example shown in FIG. 2, it is determined that the first route and the second route among the route candidates of the first vehicle are route candidates for which the occurrence of remote assistance is predicted. Similarly, for other vehicles from the second vehicle to the Nth vehicle, the presence or absence of a potential assistance request is determined for each route candidate. In this way, when selecting a route from among a plurality of route candidates, the server 40 predicts the occurrence of remote assistance for each route candidate of each vehicle. Examples of the route in which remote assistance is less likely to occur include a route having many straight lines, a route that does not pass through a traffic signal or an intersection, and a route that does not require passing.

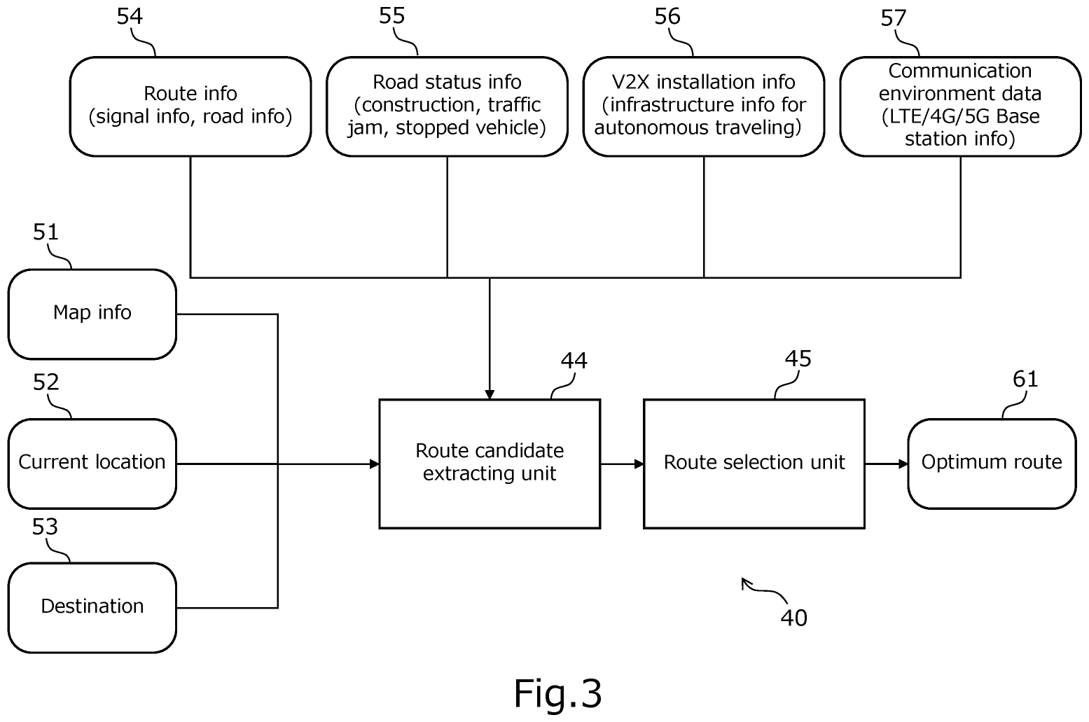

FIG. 3 is a block diagram illustrating an example of the configuration of the server 40 as a routing apparatus. The route candidate extracting unit 44 and the route selection unit 45 shown in FIG. 3 are functions of the server 40 as a routing apparatus implemented when the program 43 stored in the memory 42 and, in detail, the routing program are executed by the processor 41.

The route candidate extracting unit 44 obtains a plurality of types of information, for example, map information 51, current location 52 of each vehicle 20, destination 53 of each vehicle 20, route information 54, road status information 55, V2X installation information 56, and communication environment data 57. The route information 54 includes signal information and road information. The road status information 55 includes construction information, traffic jam information and on-road stop vehicle information. The V2X installation information 56 is infrastructure information for automatic driving. The communication environment data 57 includes LTE/4G/5G base station information.

The route candidate extracting unit 44 performs a route search for each vehicle 20 based on the obtained information 51 to 57. In the route search, a route passing through the prohibited travel area is excluded from the route candidates by referring to the operation design domain (ODD). The route candidate extracting unit 44 predicts the occurrence of remote assistance for each route candidate of each vehicle 20. For a route candidate in which the occurrence of remote assistance is predicted, the route candidate extracting unit 44 calculates a predicted occurrence time and a predicted assistance period of remote assistance. The route candidate extracting unit 44 calculates a vehicle cost with reference to the prediction result of remote assistance. The vehicle cost is represented by, for example, a function using the time required to arrive at the destination as a parameter. By selecting a route with a low vehicle cost, it is possible to cause the vehicle 20 to arrive at the destination earlier. The route candidate extracting unit 44 extracts a predetermined number of route candidates in ascending order of vehicle cost.

The route selection unit 45 selects optimal routes 61 from among the route candidates of each vehicle 20 extracted by the route candidate extracting unit 44. The optimal routes 61 is a combination of route candidates that allows the vehicles 20 under the monitoring of the remote monitoring system 100 to be operated most smoothly as a whole with a minimum number of operators 36.

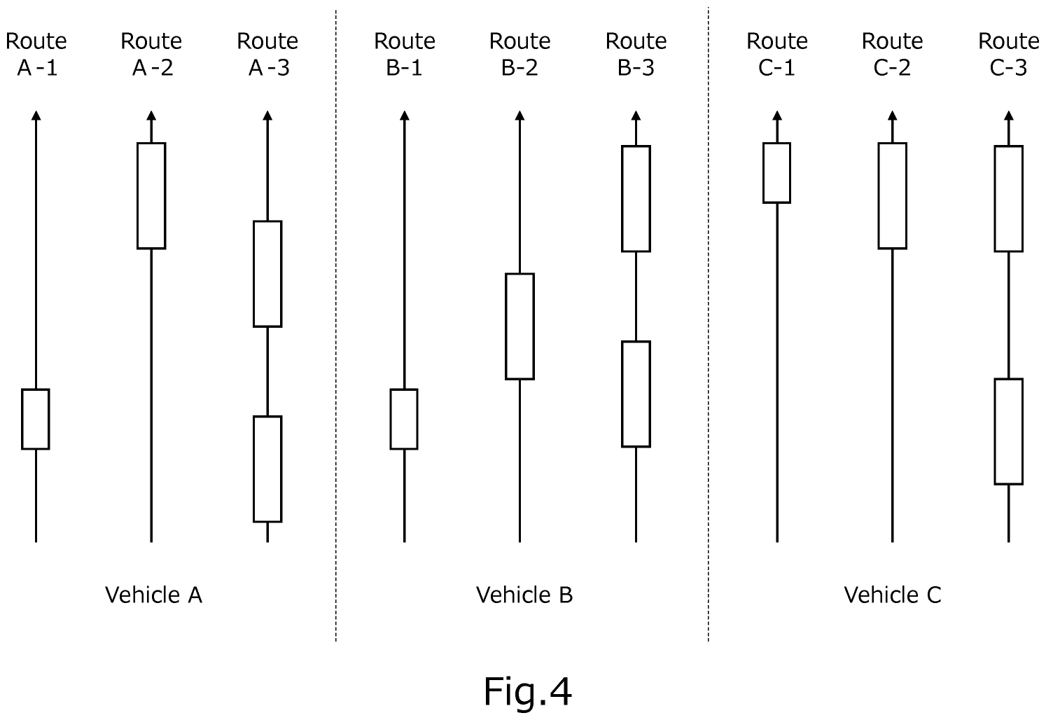

FIG. 4 is a diagram illustrating extraction of route candidates by the route candidate extracting unit 44. In the example shown in FIG. 4, for simplicity of explanation, it is assumed that there are three vehicles 20 that are monitored by the remote monitoring system 100, that is, a vehicle A, a vehicle B, and a vehicle C. It is also assumed that three route candidates are extracted for each vehicle 20. In FIG. 4, for example, a route A-1 means a first route of the vehicle A, and a route C-2 means a second route of the vehicle C. An arrow line of each route is a time axis, and a rectangle on the time axis indicates a remote assistance period for each remote assistance. As illustrated in FIG. 4, the route candidate extracting unit 44 predicts occurrence of remote assistance for each of the extracted route candidates and calculates a remote assistance period for each remote assistance that is predicted to occur.

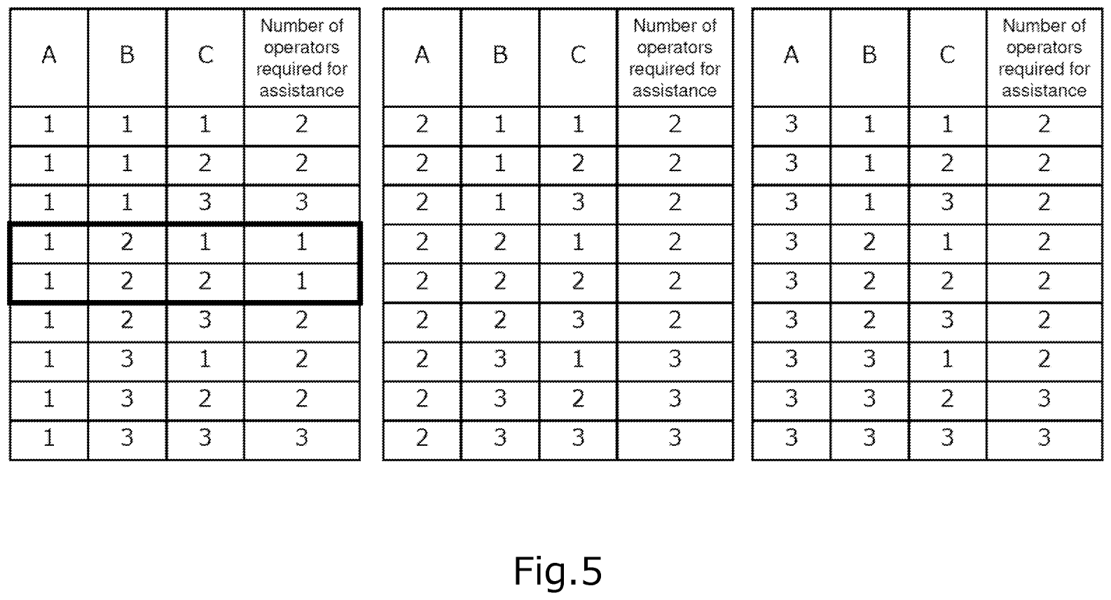

FIG. 5 is a diagram illustrating selection of optimal routes by the route selection unit 45. The route selection unit 45 calculates a time-based required number of operators, that is, the number of operators required for each predetermined time, based on the overlap of the remote assistance periods for all combinations of route candidates between the vehicles 20 under the monitoring of the remote monitoring system 100. Then, the maximum value of the time-based required number of operators is specified for all combinations of route candidates. The maximum value of the time-based required number of operators is the number of operators 36 required in the monitoring center. For example, when the remote assistance periods of the respective route candidates of the vehicles A, B, and C are as illustrated in FIG. 4, the required number of operators for the respective combinations of route candidates are as illustrated in a table in FIG. 5.

The route selection unit 45 selects a combination that minimizes the number of operators 36 required for remote assistance from among all combinations of route candidates. In the example shown in FIG. 5, when the route candidate of the vehicle A is the first route, the route candidate of the vehicle B is the second route, and the route candidate of the vehicle C is the first route, the number of operators required for remote assistance is one, which is the minimum number. This combination of route candidates is referred to as pattern α. In addition, when the route candidate of the vehicle A is the first route, the route candidate of the vehicle B is the second route, and the route candidate of the vehicle C is the second route, the number of operators required for remote assistance is one, which is the minimum number. This combination of route candidates is referred to as pattern β.

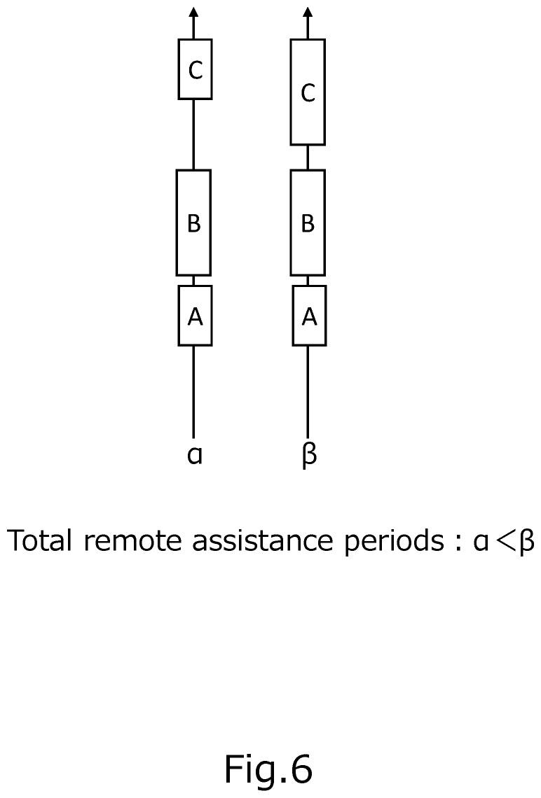

As in the example shown d in FIG. 5, when there are a plurality of combinations of route candidates in which the number of operators required for remote assistance is minimized, the route selection unit 45 selects a combination of route candidates in which the total remote assistance period is minimized. FIG. 6 is a diagram comparing the schedule of the operator 36 in the case where the combination of route candidates is the pattern α with the schedule of the operator 36 in the case where the combination of route candidates is the pattern β. An arrow line of each pattern is a time axis, and a rectangle on the time axis indicates a remote assistance period for each remote assistance. In the example shown in FIG. 6, the total remote assistance period is smaller in the pattern α than in the pattern β. In other words, the load on the operators 36 can be suppressed by adopting the pattern a. Therefore, the route selection unit 45 selects the pattern α, that is, the combination in which the route candidate of the vehicle A is the first route, the route candidate of the vehicle B is the second route, and the route candidate of the vehicle C is the first route, as the optimal routes. By performing such selection, the load on the operators 36 can be minimized.

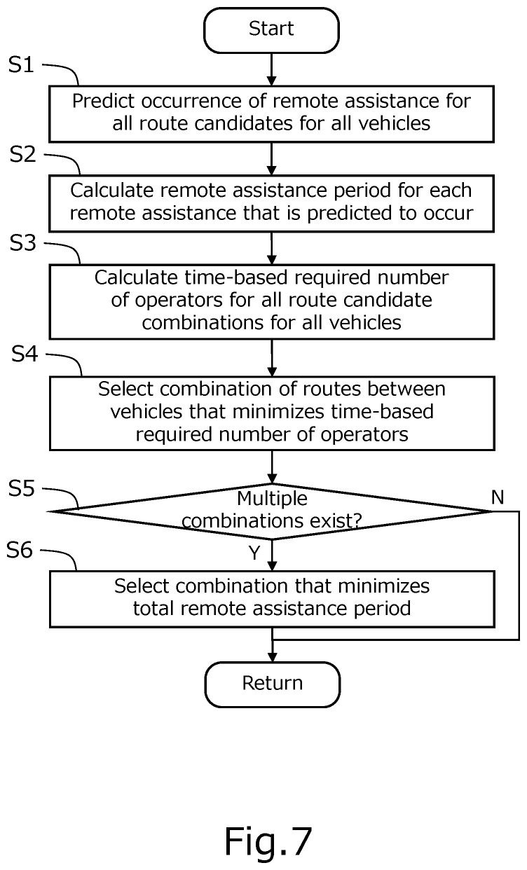

FIG. 7 is a flowchart illustrating a procedure for selecting an optimal route by the server 40 as a routing apparatus. This flowchart shows a routing method according to the embodiment of the present disclosure.

In the step S1 of the flowchart, the occurrence of remote assistance is predicted for all route candidates of all vehicles. When the step S1 is applied to the examples illustrated in FIGS. 4 to 6, the occurrence of remote assistance is predicted for each of routes A-1, A-2, and A-3 which are route candidates for the vehicles A, routes B-1, B-2, and B-3 which are route candidates for the vehicles B, and routes C-1, C-2, and C-3 which are route candidates for the vehicles C.

In the step S2, a remote assistance period is calculated for each remote assistance predicted to occur in the step S1.

In the step S3, the time-based required number of operators is calculated based on the overlap of the remote assistance periods for all combinations of route candidates for all vehicles.

In the step S4, a combination of route candidates that minimizes the number of operators for each time is selected from among all combinations of route candidates. When the step S4 is applied to the examples illustrated in FIGS. 4 to 6, the pattern α (1, 2, 1) and the pattern β (1, 2, 2) are selected as combinations of route candidates between the vehicles A, B, and C.

In the step S5, it is determined whether or not there are a plurality of combinations in which the maximum value of the time-based required number of operators is the minimum. If there is only one such combination, the next step S6 is not performed, and the combination selected in the step S4 is used as the optimal routes.

In a case where the determination result of the step S5 is positive, in the step S6, the combination in which the total remote assistance period is the minimum is selected as the optimal routes. In a case where the step S6 is applied to the examples illustrated in FIGS. 4 to 6, the pattern α (1, 2, 1) in which the total remote assistance period is the smallest is selected as the optimal routes from among the pattern α (1, 2, 1) and the pattern β (1, 2, 2).

As is clear from the above description, according to the present embodiment, it is possible to minimize the required number of operators 36 who perform remote assistance on the vehicle 20 capable of autonomous traveling.

What is claimed is:

1. A routing apparatus applied to a system configured to cause a plurality of operators to remotely monitor a plurality of vehicles capable of autonomous traveling and cause any one of the plurality of operators to perform remote assistance in response to an assistance request from any one of the plurality of vehicles, the routing apparatus comprising:
at least one memory storing at least one program, and
at least one processor coupled to the at least one memory,
wherein the at least one program is configured to cause the at least one processor to execute:
predicting occurrence of remote assistance for each of a plurality of route candidates for each of the plurality of vehicles;
calculating a remote assistance period for each remote assistance of which the occurrence is predicted;
calculating a time-based required number of operators based on an overlap of remote assistance periods for all combinations of the plurality of route candidates between the plurality of vehicles; and
selecting a combination of route candidates that minimizes a maximum value of the time-based required number of operators among all the combinations of the plurality of route candidates for the plurality of vehicles.

2. The routing apparatus according to claim 1, wherein the at least one program is configured to cause the at least one processor to execute, when there are a plurality of combinations of route candidates that minimize a maximum value of the time-based required number of operators, selecting a combination of route candidates that minimizes total remote assistance period.

3. A routing method applied to a system configured to cause a plurality of operators to remotely monitor a plurality of vehicles capable of autonomous traveling and cause any one of the plurality of operators to perform remote assistance in response to an assistance request from any one of the plurality of vehicles, the routing method comprising:
predicting occurrence of remote assistance for each of a plurality of route candidates for each of the plurality of vehicles;
calculating a remote assistance period for each remote assistance of which the occurrence is predicted;
calculating a time-based required number of operators based on an overlap of remote assistance periods for all combinations of the plurality of route candidates between the plurality of vehicles; and
selecting a combination of route candidates that minimizes a maximum value of the time-based required number of operators among all the combinations of the plurality of route candidates for the plurality of vehicles.

4. A non-transitory computer-readable storage medium storing a routing program applied to a system configured to cause a plurality of operators to remotely monitor a plurality of vehicles capable of autonomous traveling and cause any one of the plurality of operators to perform remote assistance in response to an assistance request from any one of the plurality of vehicles, the routing program being configured to cause a computer to execute:
predicting occurrence of remote assistance for each of a plurality of route candidates for each of the plurality of vehicles;
calculating a remote assistance period for each remote assistance of which the occurrence is predicted;
calculating a time-based required number of operators based on an overlap of remote assistance periods for all combinations of the plurality of route candidates between the plurality of vehicles; and
selecting a combination of route candidates that minimizes a maximum value of the time-based required number of operators among all the combinations of the plurality of route candidates for the plurality of vehicles.
